(19) United States
(12) Patent Application Publication
(10) Pub. No.: US 2013/0133446 A1
(43) Pub. Date: May 30, 2013

(54) THREADLESS CURVEABLE/FLEXIBLE SCREW ACTUATOR

(71) Applicant: FENGDONG ZHAO, (US)

(72) Inventor: FENGDONG ZHAO, (US)

(21) Appl. No.: 13/307,751

(22) Filed: Nov. 30, 2011

(51) Int. Cl. F16H 25/12

(52) U.S. Cl. 74/89.2

(57) ABSTRACT

This application relates to a device which is mounted onto a threadless curveable/flexible shaft and which converts the rotary motion of the outer of a curveable/flexible shaft into linear translation of the device. The device includes a threadless curveable/flexible shaft and two blocks with have an axial bore therethrough and a plurality of roller bearings, four of which are disposed on the block called the upper block and two of which are disposed on the block called the lower block. The upper block carries the tensioning devices which generate the friction between the bearing and the outer of the shaft. The lower block is the component to which both the driven load and the upper block are secured.

### BACKGROUND OF THE INVENTION

Lead screws and their matching nut have been used to convert rotary motion to linear motion. A ball nut and its associated lead screw can provide high efficiency under heavy loads, but require a precision ground thread and preload nuts if no backlash and smooth operation are to be achieved for light load applications. The shaft must be straight rigid rod with thread.

The threadless linear actuator is useful in converting the rotational movement to linear motion. Such a device is fully described in basic form in U.S. Pat. No. 3,777,578, U.S. Pat. No. 4,535,643, U.S. Pat. No. 4,726,242, U.S. Pat. No 4,191,059 and U.S. Pat. No. 4,947,698. These devices have several features including low cost pitch selection by simply changing the roller skew angle and automatic load protection by setting the closing spring load. All of the above inventions work on a straight rigid shaft.

U.S. Pat. No. 5,351,806 described a device which is used as a flexible screw for a conveyor in transporting containers without nuts through friction imparted on the surface.

The present invention relates to devices which are useful in converting the rotational movement of the outer of a threadless curveable/flexible shaft into linear motion along the shaft imparted from the outer of a threadless curveable/flexible shaft to the device.

The shaft is comprised of the inner of the rigid rod or steel wire wrapped with steel braided hose or steel film cover. McMaster Carr #5665K12 is one such hose.

It is an object of this invention to provide a device for converting rotational motion of the outer of a curveable/flexible shaft into linear movement of the device which will be capable of traveling along a curve.

It is another object of this invention to provide a device for converting rotational motion of the outer of the curveable/flexible shaft into linear movement of the device which will have constant thrust based upon traveling along a curve.

It is further an object of this invention to reduce the number of parts by combining parts of the track of the movement machine and simplifying the machine construction.

Other objects and advantages of the invention will become apparent from the following detailed description of the invention and the appended drawings.

### SUMMARY OF THE INVENTION

The invention in its preferred embodiment comprises a device for translating the rotational movement of the outer of a threadless curveable/flexible shaft into linear movement of the device wherein the device includes a pair of blocks which are each formed with a substantially U or O-shaped track so that there is a curvilinear bore formed through the pair of blocks when assembled. The assembled block is called the carriage. One of the blocks has two bearings and the other blocks has four bearings on it.

The blocks are held together by a fastening means which includes a pair of screws that act through springs to provide a variable compressive force which tends to move the block in a direction normal to the shaft and therefore generating a variable frictional force between the bearings of the assembled block and the outer of a threadless curveable/flexible shaft which is rotationally mounted within the bore. Each of the bearings on the block is skewed with respect to the shaft. The threadless curveable/flexible shaft comprises of an outer of steel braided hose or steel film cover and an inner of rigid rod or steel wire. The outer can transfer the rotation around the inner. The inner can curveable and the outer follow the shape of the inner. The friction between the bearings and the outer of the shaft will thrust the carriage travel when the outer of the shaft rotates.

### BRIEF DESCRIPTION OF THE DRAWINGS

FIG. 1 is an elevation view of the device in accordance with the present invention and showing hidden parts in phantom.

FIG. 2 is a view at one end of the device.

FIG. 3 is a view at the other end of the device.

FIG. 4 is a top view of the device in accordance with the present invention and showing the bolt location.

FIG. 5 is a cross-sectional view of multiple wire curveable/flexible shaft of another embodiment.

### DETAILED DESCRIPTION OF THE INVENTION

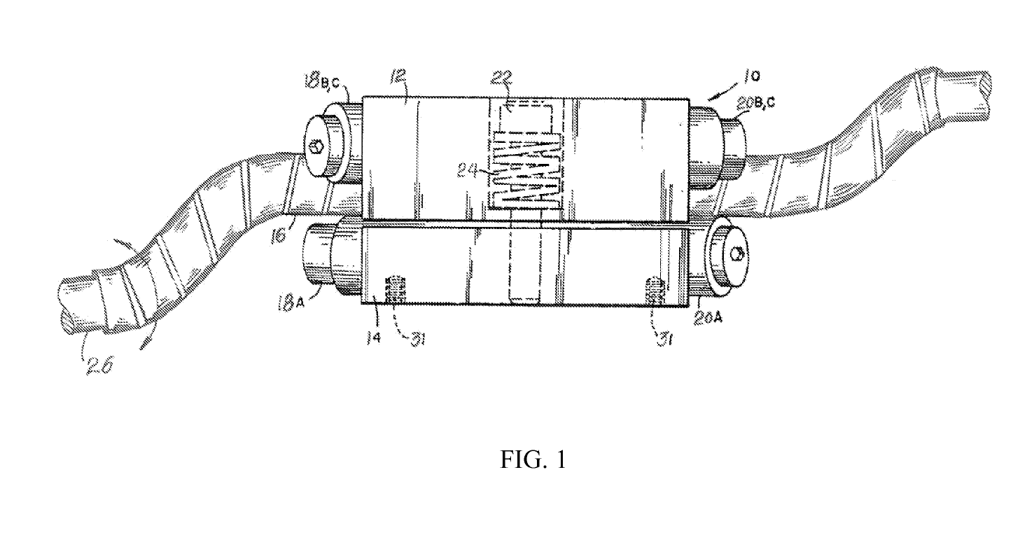

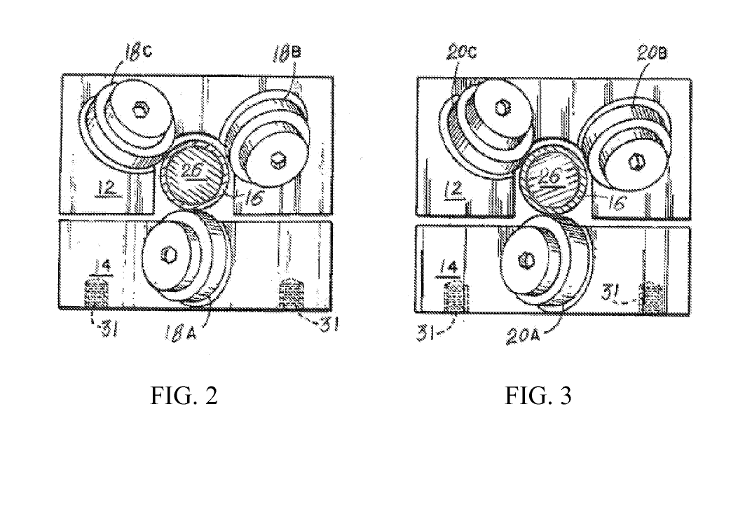

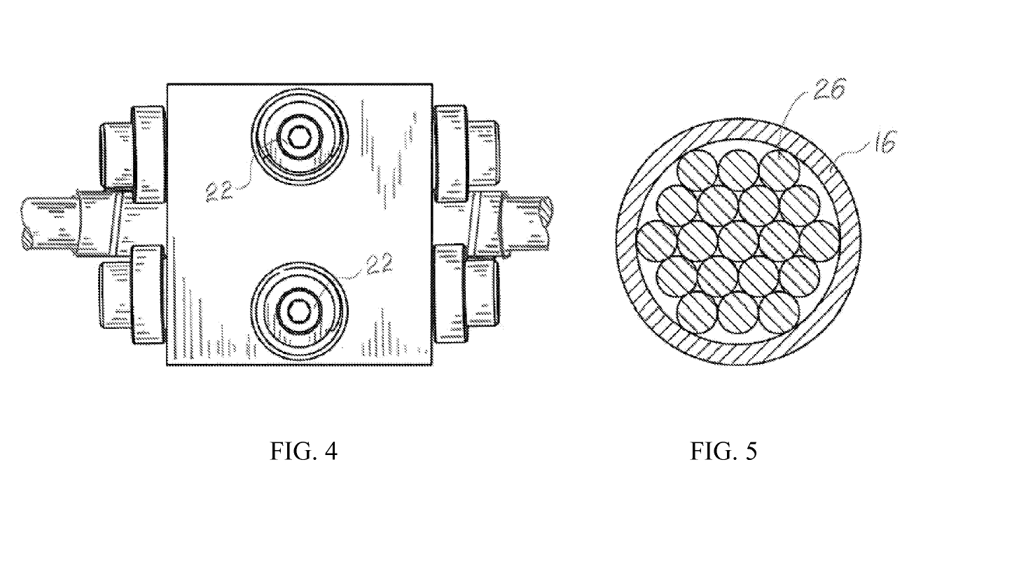

Referring to FIG. 1, the linear actuator comprises a carriage 10 comprising upper block 12, lower blocks 14, the outer of the threadless curveable/flexible shaft 16 and the inner rod or wire 26, respectively, The upper block 12 includes two bearings, 18B and 18C at one end of the block (FIG. 2) and two bearings, 20B and 20C at the other end of the block (FIG. 3). Likewise, block 14 includes one bearing, 18A at one end of the block (FIG. 2) and one bearing, 20A at the other end of the block (FIG. 3). The shaft comprising the outer 16 and rigid rod or steel wire of inner 26 (FIG. 1 and FIG. 5). Block 12 and 14 formed a U or O-shape track. As viewed from the end view of FIG. 2, whereupon after the blocks are assembled. The shaft go through the bore. Also there are two fasteners 22, each including a spring 24 which provide a variable compressive force of the block against the outer of the shaft. The outer of the shaft can rotate around the inner rigid rod or wire. The inner of the shaft is curved. The roller bearing is inclined to the axis of the shaft by the angle defined by the equation,

tan θ=L/C where

θ=angle of inclination

L=desired lead (inches per revolution)

C=circumference of drive shaft (in inches)

The pressure is maintained by using the spring force acting on the block toward the shaft.

There are several tapped mounting holes 31 on the lower block 14.

What is claimed is:

1. Apparatus for translating rotational motion of a drive member into linear motion of a carriage along the axis of the drive member comprising:
a. a substantially threadless curveable/flexible cylindrical drive member including the outer and inner.
b. a carriage member having upper and lower blocks and a plurality of roller bearings at each end of the block.
c. The shaft comprises an outer of steel braided hose or steel film cover and an inner of rigid rod or steel wire.

2. The said shaft is curveable.

3. The device according to claim 1 wherein said tensioning means includes springs that are disposed on said upper block, said spring tensioning means generating friction between said bearings and said outer of the shaft.

4. The device according to claim 1 wherein the upper block moves relative to the lower block in a direction normal to the axis of said shaft.

5. The device according to claim 1 wherein the fastening means includes a bolt passing through a hole in said upper block and engaging threads in said lower block, the head of said bolt engaging the end of a spring that surrounds said bolt and is disposed between said head and shoulder in said hole, whereby turning of said bolt will increase or decrease the tension on said spring and thus change the pressure exerted by said roller bearings on said shaft.

6. The device for translating rotational movement of the outer of a threadless curveable/flexible shaft into linear movement of the device comprising:
an upper block and a lower block, said blocks being assembled together to provide an axial bore; a plurality of roller bearings at each end of the device including two bearings at each end of the upper block and one roller bearing at each end of the lower block, each of the roller bearings being skewed with respect to the threadless curveable/flexible shaft;
fastening means including spring means to urge said roller bearings on said blocks together and against said threadless curveable/flexible shaft.
